(19) United States
(12) Patent Application Publication
(10) Pub. No.: US 2004/0107049 A1
(43) Pub. Date: Jun. 3, 2004

(54) Global positioning system receiver

(76) Inventor: Isaac D. M. White, Orlando, FL (US)

Correspondence Address: Scott P. Zimmerman, P.O. Box 3822, Cary, NC, 27519, US

(21) Appl. No.: 10/307,028

(22) Filed: Nov. 30, 2002

(51) Int. Cl. G01S 1/00

(52) U.S. Cl. 701/213; 342/357.06

(57) ABSTRACT

Methods and apparatuses are disclosed for alerting a user to points of interest. An apparatus, for example, includes a Global Positioning System receiver. The Global Positioning System receiver acquires Global Positioning System information and determines a present location of the apparatus. Memory stores a database of selected Global Positioning System information. The apparatus also includes means for comparing the Global Positioning System information with the selected Global Positioning System information stored in the memory. An alarm produces an indication when the Global Positioning System information is within a predefined range of the selected Global Positioning System information stored in memory.

### CROSS-REFERENCE TO RELATED APPLICATIONS

This application relates to the co-pending and commonly-assigned U.S. patent application Ser. No. ______, entitled “ELECTRIC FIELD DETECTOR WITH GPS,” and filed Oct. 29, 2002 (docket number BS02307/02-BS044).

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but the copyright owner otherwise reserves all copyrights whatsoever.

### BACKGROUND OF THE INVENTION

1. Field of the Invention

This invention generally relates to data communication for navigation and, more particularly, to methods and apparatuses that use a Global Positioning System to locate points of interest.

2. Description of the Related Art

A Global Positioning System (GPS) is used to accurately determine a position. A GPS receiver communicates with a network of satellites. These satellites transmit signals to the GPS receiver. The GPS receiver may then determine its position relative to the signals received from the satellites. A user of the GPS receiver can then determine their position anywhere in the world.

While these GPS receivers have been of great benefit to navigation, more utility is needed. While many users feel secure in always knowing their exact location, a GPS receiver could perform additional functions or services that further aide the user. There is, accordingly, a need for an enhanced GPS receiver that performs multiple functions.

### BRIEF SUMMARY OF THE INVENTION

These and other problems are reduced by an enhanced Global Positioning System (GPS) receiver. This invention is a GPS receiver that produces an alarm. A user carries this GPS receiver, and the GPS receiver alerts the user when nearing selected locations or when entering selected zones or regions. The invention receives Global Positioning System information and determines the present location of the apparatus. The present location of the apparatus is then compared to selected GPS coordinates stored in memory. When the present location of the apparatus is within a predefined range of one or more selected GPS coordinates stored in memory, an alarm alerts a user. The user may then take appropriate measures when in the vicinity of the selected GPS coordinates.

This invention is useful for alerting the user. This new GPS receiver may alert the user when entering pre-defined locations of interest. This GPS receiver, for example, could alert the user when in the vicinity of sporting arenas, historical sites, airports, golf courses, shopping, and other points of interest. These points of interest, of course, greatly vary from person to person. The selected GPS coordinates, then, define the locations of the user's personal points of interest. These selected GPS coordinates are stored in memory and compared to the user's present location. When the user's present location is within a defined range of the selected GPS coordinates, the invention alerts the user. The invention preferably audibly or visually alerts the user, and the invention displays the user's personal point of interest. The invention may also determine the distance to the user's personal point of interest.

This invention may also alert the user when safety precautions are required. The selected GPS coordinates, for example, may define locations requiring safety clothing, safety equipment, safety procedures, preventative measures, instructions, and other precautions. These selected GPS coordinates are stored in memory and compared to the user's present location. When the user's present location is within a defined range of the selected GPS coordinates, the invention alerts the user. The user may then respond to the alert and don safety clothing, acquire safety equipment, implement safety procedures, or implement prescribed measures.

The telecommunications industry provides an example. This invention may alert the user when measures or precautions are required in the vicinity of a telecommunications network. The selected GPS coordinates, for example, may define telecommunications network locations. These locations could include a service address, a cross-connect box, a terminal, a hand hole, a pole, a wire center, a central office, or any other network location, network facility, or network component. These selected GPS coordinates are stored in memory and then compared to the user's present location. When the user's present location is within a defined range of the selected GPS coordinates, the invention alerts the user. When, for example, the GPS coordinates indicate the user is climbing a telephone pole, the invention alerts the user to don a hard hat. If the invention determines that the user is within a predefined range of a telephone terminal, the invention alerts the user to check for foreign voltages.

One aspect of this invention describes an apparatus for receiving Global Positioning System information. This apparatus comprises a Global Positioning System receiver disposed in a housing. The Global Position System receiver acquires Global Positioning System information describing a present location of the apparatus. The apparatus also comprises a database of selected Global Positioning System information, and the database is stored in memory. The apparatus also includes means for comparing the Global Positioning System information of the apparatus with the selected Global Positioning System information in the database. An alarm couples to the means for comparing, and the alarm produces a visual and/or audible indication when the present location of the apparatus is within a predefined range of the selected Global Positioning System coordinates in the database.

Still another aspect of this invention describes a method for alerting a user of Global Positioning System information. Current Global Positioning System information is received, and the Global Positioning System information describes a current location. The current Global Positioning System information is compared to stored Global Positioning System information. An alarm is visually and/or audibly activated when the current Global Positioning System information is within a predefined range of the stored Global Positioning System information. This invention may also allow the user to deactivate the alarm under defined conditions.

Yet another aspect of this invention describes a data storage device. The data storage device comprises Global Positioning System coordinates stored on a computer readable medium. This computer-readable medium may include CD-ROM, DVD, tape, cassette, floppy disk, memory card, data card, data stick, data cartridge, other memory product. The Global Positioning System coordinates are used by a Global Positioning system receiver for comparison with a present location of the Global Positioning system receiver.

### BRIEF DESCRIPTION OF THE SEVERAL VIEWS OF THE DRAWINGS

These and other features, aspects, and advantages of this invention are better understood when the following Detailed Description of the Invention is read with reference to the accompanying drawings, wherein:

FIG. 1 illustrates one aspect of this invention;

FIG. 2 illustrates another aspect of this invention;

FIG. 3 illustrates a flowchart showing another aspect of this invention; and

FIG. 4 illustrates a flowchart showing still aspect of this invention.

### DETAILED DESCRIPTION OF THE INVENTION

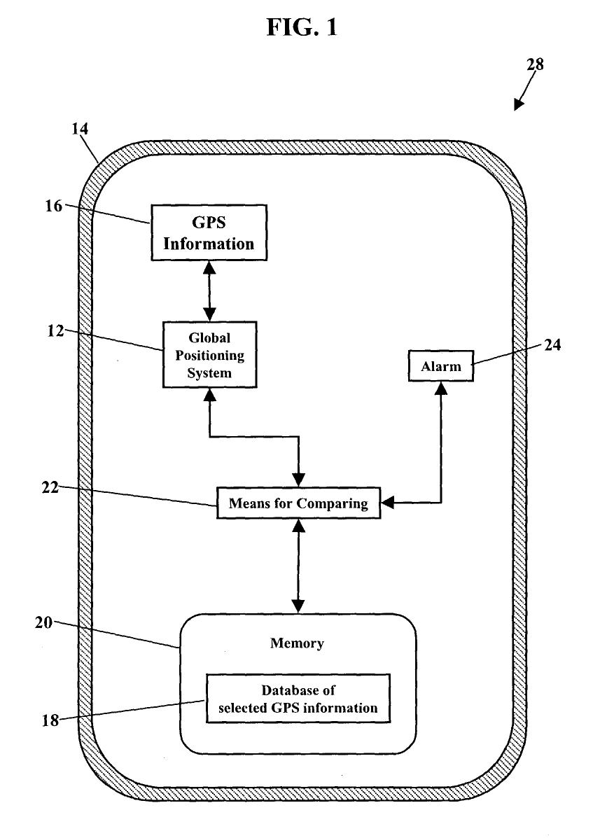

FIG. 1 illustrates one aspect of this invention. FIG. 1 is a block diagram showing an apparatus 10. This apparatus 10 comprises a Global Positioning System 12 disposed in a housing 14. The Global Position System 12 acquires Global Positioning System (GPS) information 16. This GPS information 16 is typically a signal received from a satellite (not shown) or from a base station (also not shown). The GPS information 16 may describe the present location of the apparatus 10. The apparatus 10, alternatively, may use the GPS information 16 to determine the present location of the apparatus. The apparatus 10 also comprises a database 18 of selected Global Positioning System (GPS) information. The database 18 is stored in a memory device 20. A means for comparing 22 compares the present GPS information 16 of the apparatus with the selected GPS information in the database 18. An alarm 24 couples to the means for comparing 22, and the alarm 24 produces an audible and/or visual indication when the current location of the apparatus 10 matches, or is within a predefined range of, the selected GPS information in the database 18.

This invention is useful for alerting the user. This handheld apparatus 10, for example, could alert the user when entering pre-defined locations of interest. This apparatus 10, for example, could alert the user when in the vicinity of sporting arenas, historical sites, airports, golf courses, shopping, and other points of interest. These points of interest, of course, greatly vary from person to person. The selected GPS coordinates (stored in the database 18), then, define the locations of the user's personal points of interest. These selected GPS coordinates are stored in the memory 20 and compared to the user's present location. When the user's present location is within a defined range of the selected GPS coordinates, the invention alerts the user. The invention preferably audibly and/or visually alerts the user, such as by visually displaying the user's personal point of interest. The invention may also determine the distance to the user's personal point of interest.

The user's personal points of interest are preferably loaded into memory 20. The user's personal points of interest, for example, may be input by the user or some other person using a data entry device (such as a keypad, range selector, or data link to a computer or to a computer network). A user, for example, could enter the user's personal points of interest using a keypad or keyboard that interfaces with the apparatus 10. The apparatus 10 could also interface with a computer and/or distributed computing network (such the Internet), so the user could download points of interest and save them to memory 20. The apparatus 10 could also interface with, or accept, data cards, data sticks, data cartridges, or other data storage devices. These removable data storage devices could store points of interest, and the apparatus 10 would then alert the user when entering the vicinity of these locations of interest. A removable data cartridge, for example, could store the locations of golf courses. The data cartridge is inserted into the apparatus 10, and the points of interest are uploaded into memory. When the apparatus 10 detects that it is in the vicinity of a golf course stored in the data cartridge, the alarm 24 is activated. The apparatus 10 could display the name of the golf course, its location, and the distance to the golf course. If the apparatus 10 stores the locations of Civil War battlefields, the apparatus 10 alerts the user when a battlefield is in the vicinity. These points of interest may be physically embodied on or in a removable computer-readable medium. This computer-readable medium may include CD-ROM, DVD, tape, cassette, floppy disk, memory card, and large-capacity disk (such as IOMEGA®, ZIP®, JAZZ®, and other memory products (IOMEGA®, ZIP®, and JAZZ® are registered trademarks of Iomega Corporation, 1821 W. Iomega Way, Roy, Utah 84067, 801.332.1000, www.iomega.com). The computer-readable medium is packaged for individual sale.

This invention alerts the user when entering selected zones or regions. When the present location of the apparatus 10, as defined by the GPS information 16, is within a predefined range of the selected GPS information stored in the database 18, the alarm 24 is activated. The alarm 24 alerts the user, and the user may then take appropriate measures required in the vicinity of the selected GPS information stored in the database 18. The selected GPS information (stored in the database 18), for example, may define locations requiring safety clothing, safety equipment, safety procedures, preventative measures, and other precautions. These selected GPS coordinates are stored in memory 20 and compared to the user's present location. When the user's present location is within a defined range of the selected GPS coordinates, the invention alerts the user. The user may then don safety clothing, gather safety equipment, implement safety procedures, or implement prescribed measures.

This invention may also allow the user to deselect points of interest. When, for example, the user daily travels past a certain golf course, the user may grow tired or annoyed at the daily alarm. This enhanced GPS receiver, then, could also allow the user to deactivate the alarm under defined conditions.

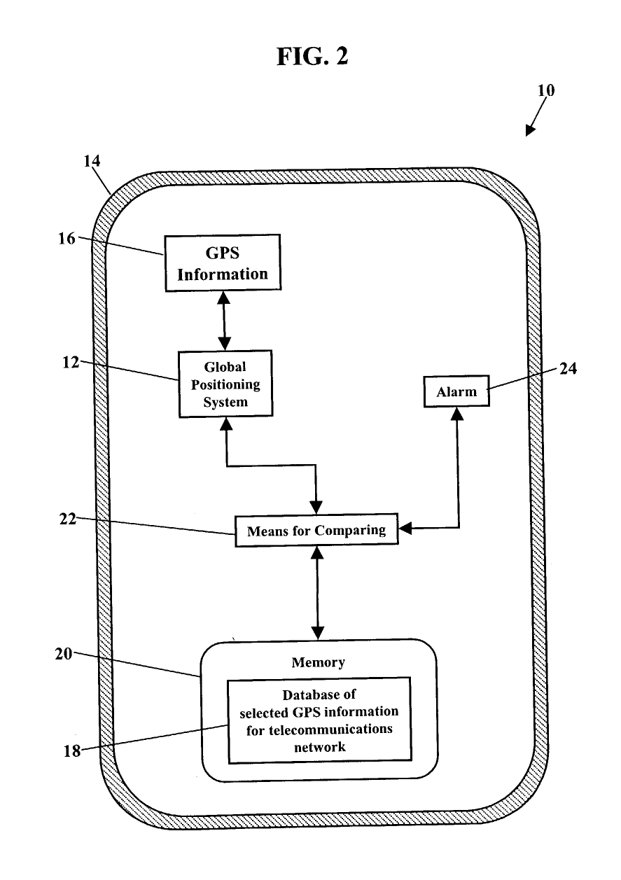

FIG. 2 illustrates still another aspect of this invention. FIG. 2 is a block diagram showing the apparatus 10 may store the locations of telecommunications network equipment. As FIG. 2 shows, the selected GPS information (stored in the database 18) may define locations of telecommunications network equipment. The database 18, for example, could store the location of a customer's service address, a cross-connect box, a terminal, a hand hole, a pole, a wire center, a central office, and/or any other telecommunications network location, network facility, or network component. These telecommunications locations are defined by the database 18 of selected GPS information. These telecommunications locations are stored in the memory 20 and then compared to the present location of the apparatus 10. When the present location of the apparatus 10 is within a predefined defined range of the selected GPS information, the alarm 24 alerts the user to use safety equipment and/or to follow safety procedures. When, for example, a telecommunications technician wears the apparatus 10 and nears a telephone/utility pole, the apparatus 10 alerts the technician to don a hard hat. If, likewise, the telecommunications technician begins to climb a ladder, the apparatus 10 detects this change in elevation and alerts the technician to don a hard hat. If the telecommunications technician is within a predefined range of a telephone terminal, the apparatus 10 alerts the technician to check for foreign, high voltages that may be present in the terminal wiring. Whenever the user's present location is within a defined range of the selected telecommunications network coordinates (stored in the database 18), the invention alerts the user. The user may then don safety clothing, gather safety equipment, implement safety procedures, or implement prescribed measures required in the vicinity of the telecommunications network location.

The GPS information (such as reference numeral 16 or that stored in the database 18) describes a location. The GPS information is preferably latitude, longitude, and elevation. The GPS information could alternatively be expressed in any x, y, and z coordinate value. These alternative x, y, and z coordinates could be expressed in U.S. Customary and British Imperial units, such as feet and miles, or in metric units, such as meters and kilometers. The Global Positioning System information could also be expressed as position, velocity, and time coordinates; however, latitude, longitude, and elevation are more readily understood. Because the principals of satellite-based navigation are well understood, the Global Positioning System 12 will not be further discussed. If the reader desires a more detailed explanation of the Global Positioning System 12, the National Aeronautical and Space Administration (NASA) offers several tutorials and background papers. See http://leonardo.jpl.nasa.gov/msl/Programs/gps.html.

The means for comparing 26 may be any circuitry. The means for comparing 26 may be any circuit design that compares information, voltages, currents, or charges. The means for comparing 26, for example, may be comparator, a combination of logic gates, software code, or preferably a processor. The means for comparing 26 communicates with the Global Positioning System 12 to receive the present location of the apparatus 10. The means for comparing 26 also communicates with the memory 20. The means for comparing 26 then compares the present location of the apparatus 10 to the selected GPS information stored in the database 18. When the present location of the apparatus 10 is within a predefined defined range of the selected GPS information, the alarm 24 alerts the user.

The predefined range may be any distance. The predefined range may be any distance, from millimeters to kilometers or from inches to miles. The predefined range may be set by the user, established by a supervisor, or prescribed by some authority. The predefined range, for example, may be input by the user or some other person using a data entry device for the apparatus 10 (such as a keypad, range selector, or data link to a computer or to a computer network). The predefined range, however, is most preferably stored in the memory 24. Each entry of the selected GPS information (stored in the database 18) may also include a corresponding predefined range. As the present location of the apparatus 10 changes, the means for comparing 26 then compares that present location to 1) the selected GPS information stored in the database 18 and to 2) the corresponding predefined range. When the current location of the apparatus 10 is within the predefined defined range of selected GPS information stored in the database 18, the alarm 24 is activated.

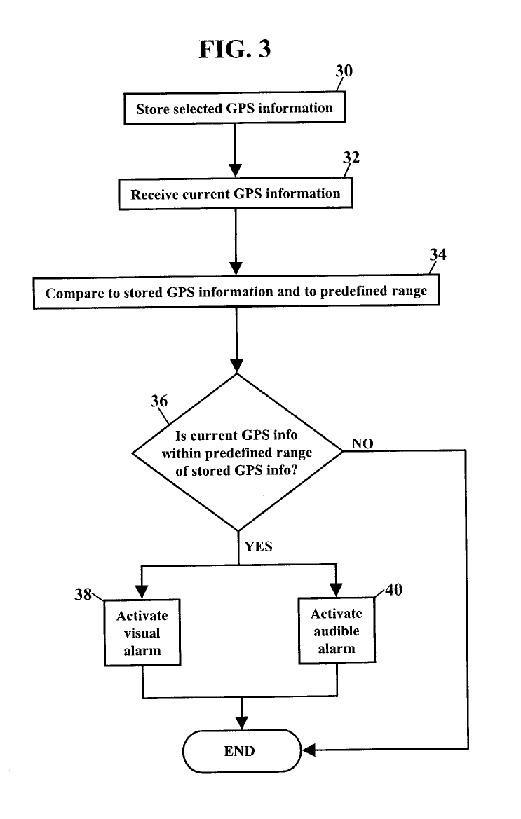

FIG. 3 is a flowchart showing one method of receiving Global Positioning system coordinates. Selected Global Positioning System information is stored in memory (Block 30). This selected Global Positioning System information defines the locations of the user's points of interest. Current Global Positioning System (GPS) information is received (Block 32). The Global Positioning System information describes a current location. The current Global Positioning System information is compared to stored Global Positioning System information (Block 34) and compared to a predefined range (Block 34). If the current Global Positioning System information is within the predefined range of the stored Global Positioning System information (Block 36), then the method checks if an alarm should be activated (Block 38). If the alarm should be activated, a visual alarm (Block 40) and/or an audible alarm (Block 42) is activated.

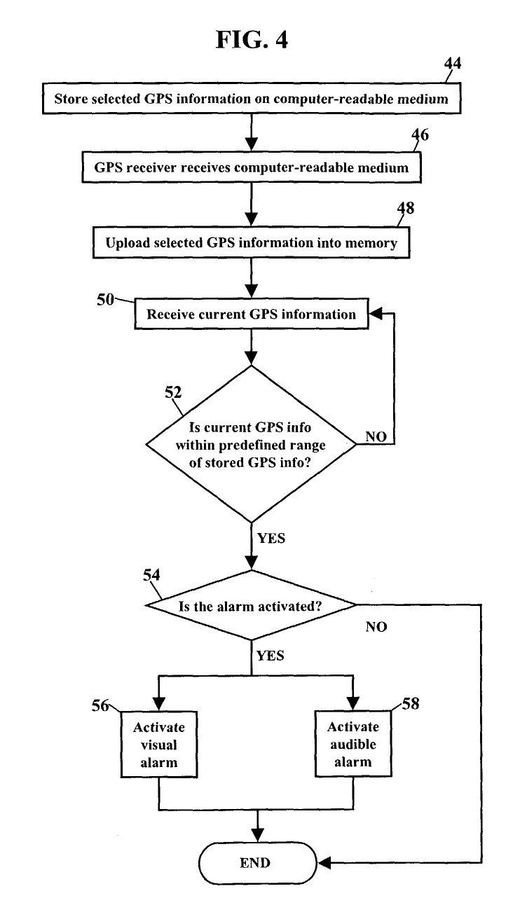

FIG. 4 is a flowchart showing another method of receiving Global Positioning system coordinates. Selected Global Positioning System information is stored on a removable computer-readable medium (Block 44). A Global Positioning System receiver is capable of accepting this computer-readable medium (Block 46). The Global Positioning System receiver uploads this selected Global Positioning System information from the computer-readable medium and into memory (Block 48). The selected Global Positioning System information defines the locations of the user's points of interest. The Global Positioning System receiver receives current Global Positioning System (GPS) information (Block 50). The current Global Positioning System information describes a current location of the Global Positioning System receiver. The current Global Positioning System information is compared to stored Global Positioning System information and compared to a predefined range (Block 52). If the current Global Positioning System information is within the predefined range of the stored Global Positioning System information, then the method checks if an alarm should be activated (Block 54). If the alarm should be activated, a visual alarm (Block 56) and/or an audible alarm (Block 58) is activated.

While the present invention has been described with respect to various features, aspects, and embodiments, those skilled and unskilled in the art will recognize the invention is not so limited. Other variations, modifications, and alternative embodiments may be made without departing from the spirit and scope of the present invention.

What is claimed is:

1. An apparatus, comprising:
a Global Positioning System receiver acquiring Global Positioning System information, the Global Positioning System receiver determining a location of the apparatus;
memory for storing a database of selected Global Positioning System information;
means for comparing the Global Positioning System information with the selected Global Positioning System information stored in the memory; and
an alarm producing an indication when the Global Positioning System information is within a predefined range of the selected Global Positioning System information stored in the memory.

2. An apparatus according to claim 1, wherein the alarm produces at least one of i) an audible indication and ii) a visual indication.

3. An apparatus according to claim 1, wherein the database of selected Global Positioning System information stores personal points of interest.

4. An apparatus according to claim 1, wherein the database of selected Global Positioning System information stores Global Positioning System information for a telecommunications network.

5. An apparatus according to claim 4, wherein the Global Positioning System information for the telecommunications network comprises at least one of a customer's service address, a cross-connect box, a terminal, a hand hole, a pole, a wire center, a central office, and a telecommunications network location.

6. An apparatus according to claim 1, wherein alarm indicates at least one of i) the use of safety equipment and ii) the use of safety procedures.

7. A method, comprising:
receiving current Global Positioning System information, the Global Positioning System information describing a current location;
comparing the current Global Positioning System information to stored Global Positioning System information; and
activating an alarm when the current Global Positioning System information is within a predefined range of the stored Global Positioning System information.

8. A method according to claim 5, wherein the step of activating the alarm comprises activating at least one of i) an audible alarm and ii) a visual alarm.

9. A method according to claim 5, further comprising storing selected Global Positioning System information.

10. An apparatus according to claim 1, wherein the stored Global Positioning System information comprises Global Positioning System information for a telecommunications network.

11. An apparatus according to claim 1, wherein the stored Global Positioning System information comprises Global Positioning System information for at least one of a customer's service address, a cross-connect box, a terminal, a hand hole, a pole, a wire center, a central office, and a telecommunications network location.

12. An apparatus according to claim 1, further comprising accepting a removable computer-readable medium storing selected Global Positioning System information.

13. An apparatus according to claim 1, further comprising uploading selected Global Positioning System information from a computer-readable medium and into memory.

14. A data storage device, comprising:
Global Positioning System coordinates stored on a removable computer readable medium, the Global Positioning System coordinates used by a Global Positioning system receiver for comparison with a present location of the Global Positioning system receiver.
